(19) United States
(12) Patent Application Publication
(10) Pub. No.: US 2015/0248681 A1
(43) Pub. Date: Sep. 3, 2015

(54) FRAMEWORKS AND METHODOLOGIES CONFIGURED TO DETERMINE PROBABILISTIC DESIRE FOR GOODS AND/OR SERVICES

(71) Applicant: SANDERS NOONAN PTY LTD, Oatley (AU)

(72) Inventor: Michael Noonan, Oatley (AU)

(21) Appl. No.: 14/636,476

(22) Filed: Mar. 3, 2015

(30) Foreign Application Priority Data
Mar. 3, 2014 (AU) 2014900690

(51) Int. Cl. G06Q 30/02; G06N 7/00; G06Q 50/18; G06N 5/04; G06Q 50/16; G06Q 30/06

(52) U.S. Cl. CPC G06Q 30/0202; G06Q 50/16; G06Q 30/06; G06Q 50/18; G06Q 40/08; G06N 5/046; G06N 7/005

(57) ABSTRACT

Technology described herein, at least in some embodiments, relates to frameworks and methodologies configured to determine probabilistic desire for goods and/or services (collectively referred to herein as “products”). Embodiments of the invention have been particularly developed in the context of a real estate environment, for example to identify consumers with a threshold probabilistic desire for financial services, such as home loans, and/or other goods and services. This is used, for instance, to generate sales leads in relation to such products. Examples are described by reference to a situation where data from a plurality of instances of real estate practice management software is utilised by a central lead generation tool.

### FIELD OF THE INVENTION

The present invention relates to technology, for example in the form of computer-implemented frameworks and methodologies, configured to determine probabilistic desire for goods and/or services. Embodiments of the invention have been particularly developed in the context of a real estate environment, for example to identify consumers with a threshold probabilistic desire for services, such as financial serviced (for example home loans and the like), and/or other goods and services. While some embodiments will be described herein with particular reference to that application, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

The process of marketing goods and/or services involves numerous challenges. In particular, there is a need to take steps to best ensure that marketing material is delivered to consumers with a reasonable probabilistic desire for the relevant goods and/or services. For instance, in the context of television advertising, a great deal of research is conducted into audience characteristics thereby to identify advertising timeslots which are more likely to be viewed by a large number of consumers belonging to a target market. Even once a target market has been successfully reached, there is a high degree of inefficiency given that numerous members of the target are unlikely to have a current desire for the relevant goods and or services. Due to these (and many other) factors, marketing inherently involves a huge degree of inefficiency.

### SUMMARY OF THE INVENTION

It is an object of the present invention to overcome or ameliorate at least one of the disadvantages of the prior art, or to provide a useful alternative.

One embodiment provides a computer implemented method for determining probabilistic desire for goods and/or services, the method including:

(i) receiving, via networked communications from a plurality of client sites, data collected via instances of practice management software respectively executing that the plurality of client sites, wherein the data is indicative of consumer behaviour recorded by the instances of practice management software;

(ii) updating a data repository that maintains, for each of a set of identified consumers, data indicative of consumer behaviour;

(iii) maintaining access to a set of one or more desire prediction rules, wherein each desire prediction rules is satisfiable based on the data indicative of consumer behaviour;

(iv) monitoring the data indicative of consumer behaviour thereby to determine whether any of the desire prediction rules are satisfied in respect any of the consumers; and

(v) in the case that a given one of the desire prediction rules is satisfied in respect of the specific one of the consumers, performing an action associated with that one of the desire prediction rules.

One embodiment provides a computer implemented method wherein the instances of practice management software are instances of real estate practice management software.

One embodiment provides a computer implemented method wherein the data indicative of consumer behaviour is indicative of consumer behaviour observed in relation to real estate activities.

One embodiment provides a computer implemented method wherein the consumer behaviour observed in relation to real estate activities includes data relating to any one or more of the following activities:

(a) making an enquiry;

(b) attendance at a property viewing;

(c) attendance at a property auction;

(d) the making of an offer in respect of a property;

(e) request/obtaining of a contract in respect of a property;

(f) a settlement in respect of a property purchase;

(g) determination of a settlement date in respect of a property purchase; and

(h) determination of occupation commencement date in respect of a property rental.

One embodiment provides a computer implemented method wherein the data relating to any one or more of the activities includes, for a given one of the activities, any one or more of: a date; a value; a value range; and a location.

One embodiment provides a computer implemented method wherein updating the data repository that maintains, for each of a set of identified consumers, data indicative of consumer behaviour, includes, for each of a plurality of data packets received from the client sites:

receiving the data packet;

processing the data packet thereby to extract identification data and behaviour data;

querying the data repository thereby to identify a consumer record corresponding to the identification data; and

associating the behaviour data with the identified consumer record.

One embodiment provides a computer implemented method wherein: a first client site maintains, for its instance of practice management software, a first set of data relating to a first consumer; a second a second client site maintains, for its instance of practice management software, a second set of data relating to a the consumer, but independent of the first set of data; and wherein the data repository amalgamates data indicative consumer behaviour for the first consumer derived from the first and second sites.

One embodiment provides a computer implemented method wherein each desire prediction rule is associated with a specific product, wherein the product includes any one or more of the following:

financial services;

legal services;

utilities services;

household services; and

insurance services.

One embodiment provides a computer implemented method wherein each desire prediction rule is associated with a specific product, wherein the product includes any one or more of the following financial services: home loans; bridging loans; annuity products; financial planning services.

One embodiment provides a computer implemented method wherein each desire prediction rule is associated with a specific product, wherein the product includes any one or more of the following insurance services: building insurance; mortgage insurance; home and contents insurance; loan protection insurance; landlord insurance; life insurance; and income protection insurance.

One embodiment provides a computer implemented method wherein each desire prediction rule is associated with a specific product, wherein the product includes any one or more of the following legal services: conveyancing; insolvency; and family law.

One embodiment provides a computer implemented method wherein each desire prediction rule is associated with specific product, and the rule is satisfied when data indicative of behaviour for a given consumer represents a predefined point in a product desire timeline.

One embodiment provides a computer implemented method wherein the action includes generating a lead, and wherein the method further includes monitoring conversion of leads in respect of a given product, and in response selectively varying the predefined point in a product desire timeline for that product.

One embodiment provides a computer implemented method wherein the action includes generating a notification indicative of an identified threshold probabilistic desire for the specific one of the consumers in respect of a product associated with the satisfied desire prediction rule.

One embodiment provides a computer implemented method for determining probabilistic desire for goods and/or services, the method including:

(i) receiving, via networked communications from a plurality of client sites, data collected via instances of real estate practice management software respectively executing that the plurality of client sites, wherein the data is indicative of consumer behaviour recorded by the instances of real estate practice management software;

(ii) maintaining access to a set of one or more desire prediction rules, wherein each desire prediction rule is satisfiable based on the data indicative of consumer behaviour;

(iii) monitoring the data indicative of consumer behaviour thereby to determine whether any of the desire prediction rules are satisfied in respect any of the consumers; and

(iv) in the case that a given one of the desire prediction rules is satisfied in respect of the specific one of the consumers, performing an action associated with that one of the desire prediction rules.

One embodiment provides a computer implemented method for determining probabilistic desire for a home loan product, the method including:

(i) receiving, via networked communications from a plurality of client sites, data collected via instances of real estate practice management software respectively executing that the plurality of client sites, wherein the data is indicative of consumer behaviour recorded by the instances of real estate practice management software;

(ii) monitoring the data indicative of consumer behaviour based on a prediction algorithm thereby to identify one or more consumers having a threshold predicted probabilistic desire for a home loan; and

(iii) providing a notification identifying the one or more consumers having a threshold predicted probabilistic desire for a home loan.

One embodiment provides a computer program product for performing a method as described herein.

One embodiment provides a non-transitory carrier medium for carrying computer executable code that, when executed on a processor, causes the processor to perform a method as described herein.

One embodiment provides a system configured for performing a method as described herein.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

### BRIEF DESCRIPTION OF THE DRAWINGS

Embodiments of the invention will now be described, by way of example only, with reference to the accompanying drawings in which:

FIG. 1 schematically illustrates a framework according to one embodiment.

FIG. 2 illustrate exemplary processes according to embodiments.

FIG. 3 illustrates a client-server framework leveraged by various embodiments.

### DETAILED DESCRIPTION

Technology described herein, at least in some embodiments, relates to frameworks and methodologies configured to determine probabilistic desire for goods and/or services (collectively referred to herein as “products”). Embodiments of the invention have been particularly developed in the context of a real estate environment, for example to identify consumers with a threshold probabilistic desire for financial services, such as home loans, and/or other goods and services. This is used, for instance, to generate sales leads in relation to such products. While some embodiments will be described herein with particular reference to that application, it will be appreciated that the invention is not limited to such a field of use, and is applicable in broader contexts.

### General Overview

In overview, technologies disclosed herein leverage data collected via operation of practice management software are a plurality of remote client sites, thereby to enable centralised determinations as to consumers' probabilistic desire for goods and/or services. For example, this may be used to generate sales leads (i.e. provide an alert that a sales lead should be generated when predefined conditions are met, those conditions in effect indicating that a particular consumer's probabilistic desire for a product has reached a threshold level). In some embodiments, this is achieved by monitoring consumer behaviour, thereby to predict a time at which they have a threshold probabilistic desire. This may be coordinated by a rules engine, which monitors a set of consumer data and generates an alert when predefined conditions are met.

In the disclosure below, an example of implementation in the field of real estate is specifically considered. It should be appreciated that the technologies and methodologies, whilst particularly beneficial in such a field, may find further application in other fields. In that regard, embodiments may be implemented in substantially any scenario where practice management software executes at a plurality of client sites, and data is collected and processed centrally based on the operation of that software, thereby to determine probabilistic demand for goods and/or services.

References are made herein to “instances” is practice management software. The precise definition of what is meant by an “instance” may vary between embodiments. For instance, the following examples are specifically mentioned:
An “instance” defined by an individual software install at a client machine. For example, monitoring may occur in respect of interactions with that individual install, thereby to enable updating of a central remote data repository which spans multiple instances.
An “instance” defined by a set of networked terminals that each execute the same (or compatible versions of the same) practice management software. These terminals are all commented to a common data repository, which maintains data derived from (and used by) the practice management software running at each of the terminals. Monitoring may occur in respect of interactions with each individual terminal, or at a centralised level (for example by reference to updates made in the common data repository or the like), thereby to enable updating of a central remote data repository which spans multiple instances.
An “instance” defined by a set of networked terminals that each access the same cloud-hosted practice management software, leveraging the same set of back-end data (which relates to a common set of clients, for example. Monitoring may occur in respect of interactions with each individual terminal, or at a centralised level (for example by reference to updates made in the common data repository or the like), thereby to enable updating of a central remote data repository which spans multiple instances.

These are examples only. The overall concept is that practice management software is used by businesses, and multiple businesses may use the same software, but their own instances of that software. There is a first level of data which is specific to each business, and in the embodiments discussed below there is additionally a second level of data which is collected from the plurality of businesses and stored in a centralised and combined manner. This second level is not shared between the businesses in the context of conventional operation of their practice management software (i.e. they do not access data relating to each others' clients); the second level is primarily used for centralised lead generation purposes.

### Exemplary Framework

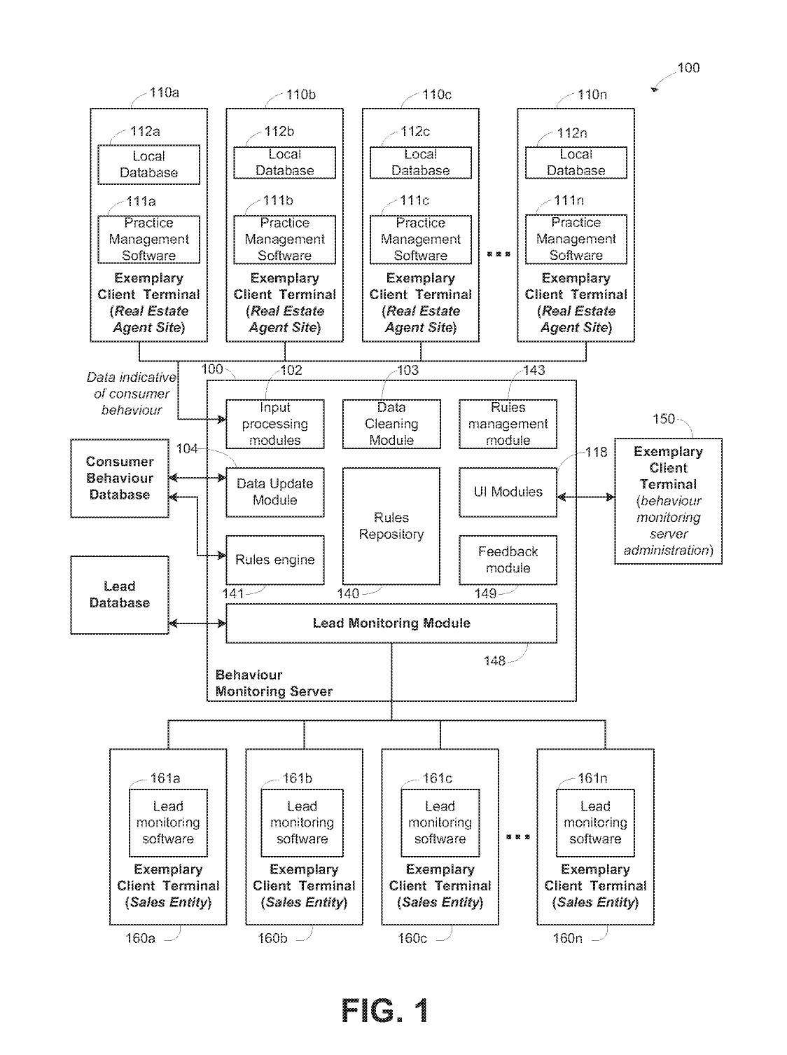

FIG. 1 illustrates an exemplary framework 100. Various methodologies performed by components of framework 100, along with components themselves, and combinations thereof, may be considered as individual embodiments of the underlying technologies. The framework is illustrated and described by reference to components that are functionally and/or logically identifiable. Groups of these may be collectively provided by common hardware and/or software components in certain cases.

Framework 100 centres upon a consumer behaviour monitoring server 101. Server 101, as discussed in more details below, is configured for monitoring consumer behaviour and generating sales lead data as a result. Server 100 may, in practice, be defined by either a single server component, or by a plurality of networked components (which may be distributed between multiple physical locations). The server is configured to execute computer executable code stored on a carrier medium thereby to provide functionalities described herein.

Framework 100 also includes a plurality of client terminals 110a-110n, located at various client sites, each of which executes an instance of practice management software 111a-111n and a local client information database 112a-112n. These may include:
One or more client terminals that execute practice management software which is inherently adapted to communicate with server 100; and/or
One or more client terminals that execute practice management software which is not inherently adapted to communicate with server 100, but instead configured via an API/plugin or the like to communicate with server 100.

Furthermore, although described as “client terminals”, it should be appreciated that in the context of a given site these may operate as a local server device, which enables a plurality of local client devices to provide practice management software user interfaces which leverage a common local database associated with the local server. That is, the use of the term “client” is to designate terminals 110a-110n as clients relative to server 100.

In a further embodiment, cloud-hosted practice management software is used by one or more of client terminals 110a-110n. It will be appreciated that, in some such implementations, each of client terminals 110a-110n provides a local user interface rendering of software for which the substantive software code is hosted by a server. Furthermore, the “local” databases are preferably cloud hosted, perhaps using common data storage infrastructure. Hence, in cloud implementations, instance of practice management software 111a-111n and local client information databases 112a-112n are contextually defined, and leverage much of the same centralised infrastructure whilst providing functionally discrete instances.

In examples specifically described herein, the practice management software is real estate practice management software. This software enables the management of various activities within a real estate practice, including the likes of:
Queries regarding property purchase/sale. These typically are recorded by reference to data such as consumer ID data, a value, and a location.
Queries regarding property rentals (by prospective landlord or tenant). These typically are recorded by reference to data such as consumer ID data, a value, and a location.
Attendance at inspections and/or auctions. These typically are also recorded by reference to data such as consumer ID data, a value, and a location.
Offers made in respect of property sales and/or rentals (and acceptance/refusal of such offers).
Requests for contracts, exchange of contracts, settlement process, and other activities relevant to the purchase/sale of property.
Activities relevant to the rental of property (including, for example, determination of an occupation date).

It is not necessary that each instance of practice management software provide all of these functionalities; for example the software may provide a plurality of suites (such as a “sales management suite” and a “rentals management suite”), and a given client site might use only one or a selection of available suites.

The practice management software is preferably used by multiple real estate businesses which do not share data between each other. For example, Real Estate Group A might have i offices, which each use the practice management software, and share data among themselves, and Real Estate Group B might have j offices, which each use the practice management software, and share data among themselves. However, the i offices of Real Estate Group A do not share consumer data with the j offices of Real Estate Group B. This is an inherent aspect of business; competing businesses do not share consumer data relating to their own consumers. However, as discussed further below, they both share such data with server 100 thereby to enable generation of sales leads. In some embodiments this is encouraged by a referral arrangement whereby a commission from a successful sales lead is returned to the real estate group (or individual real estate office) that provided data that caused the sales lead to be generated.

Each instance of software 111a-111n at clients 110a-110n is configured to periodically provide data to server 100, this being data indicative of consumer behaviour recorded by the instances of practice management software. This data may be provided piecemeal (e.g. each time a new consumer behaviour event is recorded), or in batched communications (e.g. on an hourly basis).

An exemplary data format, for a given item of behaviour data, is as follows:
(consumer ID data); (interaction code); (value)

In practical implementations the data format may be significantly more complex, depending on the richness of data being collected. However, the above example indicates some key aspects of the nature of data provided. In particular, each discrete item of behaviour data communicated to server 100 includes at least one piece of consumer ID data (preferably multiple pieces). This may include a consumer ID code known to server 100 (for example server 100 provides those codes to applications 111a-111n following central registration of consumers), a name, phone number, address, and so on. Each item of behaviour data also includes one or more interaction codes (for example indicating whether the item relates to a property purchase query, exchange of contracts, and so on) and one or more values associated with each interaction code (for example property value ranges, dates, locations, and so on). Preferably the data is also indicative of a source (i.e. form whom the data is transmitted), for example to facilitate a referral commission arrangement.

Server 101 includes input modules 102, which are configured to receive behaviour data from client terminals 110a-110n. In this example, input modules are additionally configured to receive behaviour data from other sources 115, which may include various forms of software applications, including various monitoring applications which derive consumer behaviour data from non-real estate sources. For example, these may monitor the likes of public databases, websites, and so on.

Input modules 102 receive data, and provide that data to a data cleaning module 103. Data cleaning module 103 is responsible for “cleaning” received data (for example via normalization or the like) thereby to ensure that it is in a format suitable for recording in a central database 130 associated with server 100. For example, database 130 maintains a single consumer record for each consumer. However, a given consumer for which such a consumer record is defined in database 130 might be defined differently in a plurality of the local databases 112a-112n. For instance, persona information captured for a given consumer between individual client sires may vary. Server 100, on the other hand, normalises identity thereby to track consumer behaviour across multiple client sites (noting that the client sites do not typically share that information among themselves).

Identity normalisation enables server 100 to track consumer behaviour in the context of queries made via multiple real estate agents. For instance, a given consumer might contact various real estate agents over a period of time, seeking information about different properties in different locations with different values. Server 100, via identity normalisation, is able to track such activity, thereby to monitor consumer behaviour over time independent of the specific real estate agents/sites with which the consumer is dealing. Identity normalisation may include processing consumer ID data for a particular item of behaviour, determining a percentage likelihood that it belongs to a known consumer record, and in the case that the percentage likelihood exceeds a threshold value, determining that the relevant item belongs to that specific consumer record (for example this accounts for a situation where one agent records a person as “Mike Smith” and another as “Michael Smith”, who are actually the same person, which might be identified by common contact telephone numbers). In the case that the percentage likelihood is below the threshold, a new consumer record may be defined. Preferably server 100 provides functionality to enable merging of consumer records (in some embodiments manually) on an ongoing basis.

Data cleaning module 103 may also be responsible for ensuring that data values are within acceptable ranges and so on, thereby to prevent clearly incorrect or unacceptable values from being input into database 130. For example, it may be determined that a property value of $1 is an unacceptable value, and hence it is discarded (or alternately the real estate site contacted and asked to correct the value).

A database update module 104 is responsible for updating database 130 based on the cleaned data. That is, module 104 is responsible for updating a data repository that maintains, for each of a set of identified consumers, data indicative of consumer behaviour. The precise manner in which data in database 130 is organised is a matter of implementation choice, and varies between embodiments. For example, one approach is to define a record for each consumer, and associate with that record:
(i) Identifying information, such as name, phone numbers, email, etc.; and
(ii) Behaviour information, defined by a plurality of events, wherein each event is defined by an event type, event date, and one or more event values.

Server 100 also includes a set of desire prediction rules 140. Each desire prediction rules is satisfiable based on the data indicative of consumer behaviour. For example, each rule may be defined based on one or more “if” criteria and one or more “then” criteria. The “if” criteria may draw on any of the data in database 130, and are defined so as to be representative of particular behaviour observations (which are in turn indicative of probabilistic desire for goods and/or services). For example, rules may consider the likes of:
Increase/decrease in a value of properties being considered over a period of time.
Regularity of attendance at inspections/auctions/etc.
Dates for defined actions, such as settlement dates, occupation dates, and so on.
Reasons for which a property is being considered (primary residence, investment/rental, etc.), which may be explicitly defined in database 130 or implicitly derived from other data.
Property types (retail/industrial/commercial).

The manner by which specific rules are devised thereby to represent probabilistic demand may be based on empirical evidence, experiential feedback (discussed further below), educated predictions, and so on. The precise rules implemented fall beyond the scope of the present disclosure; the present disclosure focuses on a flexible framework that allows the creation and implementation of such rules based on whatever specific factors are custom made for a given implementation.

In some embodiments each desire prediction rule is associated with specific product, and the rule is satisfied when data indicative of behaviour for a given consumer represents a predefined point in a “product desire timeline”. For example, based on observed behaviours, it is possible to predict a consumer's position on an objectively predefined purchase timeline for a given product (or indeed whether a consumer is on such a timeline). Data received from practice management software at client sites allows analysis of the product purchase timelines on which a given consumer may be placed, and positions on those timelines (for example relative to benchmark dates). A determination is made, for each product-specific purchase timeline, as to a point in time at which probabilistic desire for the product is at a maximum (or at least above a threshold level), via what may be a predominately subjective determination process based on the likes of past experience, research, and market understanding. Rules are then able to be defined to automate the generation of a sales lead for that a point in time (for example by triggering a sales lead a predetermined period preceding, for example one week). This assists sales entities in having leads ready to be actioned at appropriate times.

Desire prediction rules are generated and/or modified using a rules management module 143. In the illustrated embodiment, this is accessed via an exemplary client terminal 150. More specifically, server 100 provides user interface modules 118 which enable a user of client terminal 150 to access various functionalities provided by server 100 (including, but not limited to generation and/or modification of desire prediction rules via module 143), for example via a web-browser rendered user interface.

Although in the example of FIG. 1, rules 141 are illustrated as being maintained by server 100, in other embodiments they are maintained externally of server 100. In either case, all that is necessary is that server 100 maintain access to the rules (i.e. so that the rules can be read and implemented).

A rules engine 142 is responsible for executing rules 141. That is, rules engine 142 is responsible for monitoring the data indicative of consumer behaviour in database 130 thereby to determine whether any of the desire prediction rules 141 are satisfied in respect any of the consumers. In the case that a given one of the desire prediction rules is satisfied in respect of the specific one of the consumers, rules engine 142 is responsible for triggering performance of an action associated with that one of the desire prediction rules.

It will be appreciated that, as is customary with any arrangement including rules and a rules engine, there is a high degree of flexibility in terms of actions that are performed when a rule is triggered (i.e. the “THEN” component of rules).

For the present purposes, one specific category of action is primarily considered, that being the generation of a sales lead. This, in some embodiments, includes generating a notification indicative of an identified threshold probabilistic desire for the specific one of the consumers in respect of a product associated with the satisfied desire prediction rule. However, it will be appreciated that various other forms of actions might be implemented, including actions that update data in database 130 (for example to populate advanced data fields which are not inherently populated by virtue of data received from the client sites).

Each desire prediction rule is associated with a specific product (wherein the “product” may be defined by goods and/or services). The product may include any one or more of the following:
Financial services, such as home loans; bridging loans; annuity products; financial planning services. For example, a rule may be generated to provide a lead for a home loan when certain behaviours are observed in relation to property inspections, offers, and so on. As a further example, a rule may represent that if a consumer is selling one property for a value in range X and looking at other properties in a vale range Y, wherein X>Y, then there is a probabilistic desire for bridging finance.
Legal services, such as conveyancing; insolvency; and family law. For example, a rule may be triggered to generate a sales lead for conveyancing services based on a consumers' observed position (based on behaviour data) in a property sale/acquisition timeline.
Utilities services, such as power, water, electricity, communications (such as phone and/or internet), subscription television services, and so on. For example, a rule may be defined such that a subscription television sales lead is generated when a person signs a tenancy agreement, or at a point in time defined relative to such a signing (or relative to an anticipated signing).
Insurance services, such as building insurance; mortgage insurance; home and contents insurance; loan protection insurance; landlord insurance; life insurance; and income protection insurance.
Household services, such as cleaning services (for example of the type that might be applicable at the termination of a tenancy agreement).

With these examples in mind, it will be appreciated how monitoring a consumer's behaviour relative to real estate activities is able to provide useful and accurate guidance as to probabilistic desire for goods and/or services. Server 100 is used ti enable implementation of such rules thereby to generate sales leads, so as to enable a product provider to contact a given consumer at an appropriate time, this time being “appropriate” in the sense that it coincides when their predicted probabilistic desire is at a peak level. This allows for a sales lead to be actioned at, around, or in some cases immediately preceding time when a consumer begins to consider a need for a particular product. For example, when a consumer enters into a new tenancy agreement, they have in most cases not considered utilities connections, and hence there is benefit in providing to utilities providers sales leads for that consumer at or around the time the agreement is signed (or potentially at a later date, depending on more detailed analysis of consumer behaviour and analysis of successful lead conversions).

In the illustrated embodiment, rules engine 142 provides data to a lead management module 148. This data includes data indicative of a consumer to whom the lead relates, a product (i.e. goods and/or services) to which the lead relates, and optionally other data. This results in the generation of a lead record in a lead database 131, and the provision of lead data to one or more sales terminals 160a-160n, which is each associated with a sales entity (for example a company or person). Each sales terminal 160a-160n executes lead monitoring software 161a-161n (which may be software in the sense of a code downloaded from a web server and rendered via a web browser), which enables a user to track the process of a lead (for example when the lead is generated/received, actions taken, conversion, and the like). Data inputted via lead monitoring software is propagated back to lead management module 148, and database 131 updated as a result. This enables server 100 to monitor the progress of leads, for example in terms of which are acted upon, on what timeframes, by whom, and the end results (for example conversions to sales, value/nature of sales, and so on).

The particular sales terminal/terminals to which the lead data is communicated may be determined by either the rules engine (i.e. determined by the desire prediction rues) and/or by the lead management module (separate from the desire prediction rules). Selection criteria may be based on one or more of the following factors:
Suitability of sales entity (for example by reference to location, prediction/knowledge of consumer preferences, market position, and the like).
Historical conversion rates (for example sales entities with higher conversion rates may be favoured).
Best offers (for example sales entities identify whether they provide special pricing to consumers referred via system 100).
Utilisation of lead monitoring software (for example sales entities who are observed to correctly and promptly update the lead monitoring software are favoured).
Subscriptions/payments (for example favouring entities who pay higher fees).
Random selections.
Proportional distribution.

Other factors may also be used.

A feedback module 149 monitors data in database 131, and performs analysis as to the success/failure of leads generated by system 100. This analysis may be used for either or both of reporting purposes (i.e. providing data thereby to educate as to effectiveness of leads) and rule improvement. In relation to the latter, this may include utilising the feedback is used to update/modify rules based on observations, thereby to improve future performance. By way of example, timing factors may be observed, thereby to identify an optimal point in time (relative to a defined date, such as offer acceptance, settlement, occupation, etc.) at which to contact a consumer regarding a particular product.

Lead management module 148 may also be responsible for managing a referral commission arrangement, whereby by a commission (defined based on a flat rate, percentage, and/or otherwise) is determined and allocated to a Real Estate Agent site (and in some cases additionally to an administrator of server 100). In terms of the real estate agent sites, this allows the generation of additional income simply from correctly using their practice management software.

### Exemplary Processes

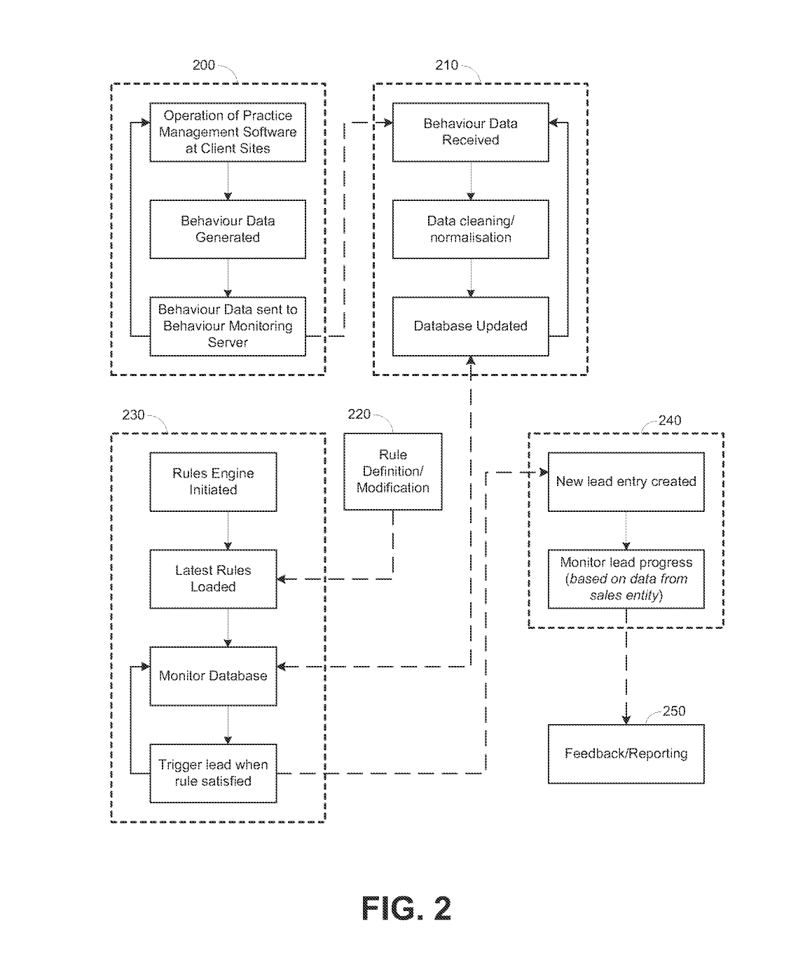

FIG. 2 illustrates a set of interlinked processes according to various embodiments. These may be implemented using framework 100, or via other means.

Process 200 represents operation of practice management software, for example at a real estate site. The operation of this software results in generation of behaviour data. For example, the software is updated to reflect that a Consumer A has made a query with attributes B, C and D. This results in generation of behaviour data indicative of Consumer A and a query with attributes B, C and D. The behaviour data is sent to a behaviour monitoring server.

Process 210 represents a process performed at a behaviour monitoring server, triggered from process 200. Behaviour data is received, and cleaned/normalised prior to being written to a consumer behaviour database. This database, as a result, maintains a record of consumer behaviour derived from activity of a plurality of instances of practice management software distributed across multiple sites.

It will be appreciated that, whilst the illustrated example shows all behaviour monitoring occurring centrally, in some embodiments aspects of behaviour monitoring are implemented via software processes that execute at distributed locations (for example at client terminals).

Process 220 represents a rule definition/modification process. In overview, rules are generated to equate database values (i.e. data indicative of consumer behaviour) with a trigger to generate a sales lead for a particular product (based on probabilistic desire for that product). For example, the rules may determine whether a client has reached a point in a defined (or conceptually definable) product purchase timeline at which generation of a sales lead would be optimal.

Process 230 represents operation of a rules engine. In overview, the rules engine is initiated, and the latest rules loaded. The database is then monitored thereby to identify whether one or more rules are satisfied. Where a rule is satisfied, a sales lead is triggered.

Process 240 represents a sales lead monitoring process. A new lead entry is created upon the triggering of a sales lead via process 230, and progress of that lead entry is monitored by way of data received from a sales entity to whom the lead is assigned. This may include data indicative of actions taken to progress lead, conversion, and value. This leads on to a feedback/reporting process 250, which enables improvement of the other processes and rules, thereby to potentially improve lead conversion rates.

### Specific Example: Home Loan Leads

In one embodiment, framework 100 is adapted specifically for the purpose of generating leads for home loans. In that regard, data is collected from the multiple instances of real estate practice management software, and processed based on predefined rules/algorithms which identify optimal points in time at which to contact consumers regarding home loans.

### Exemplary System-Level Overview

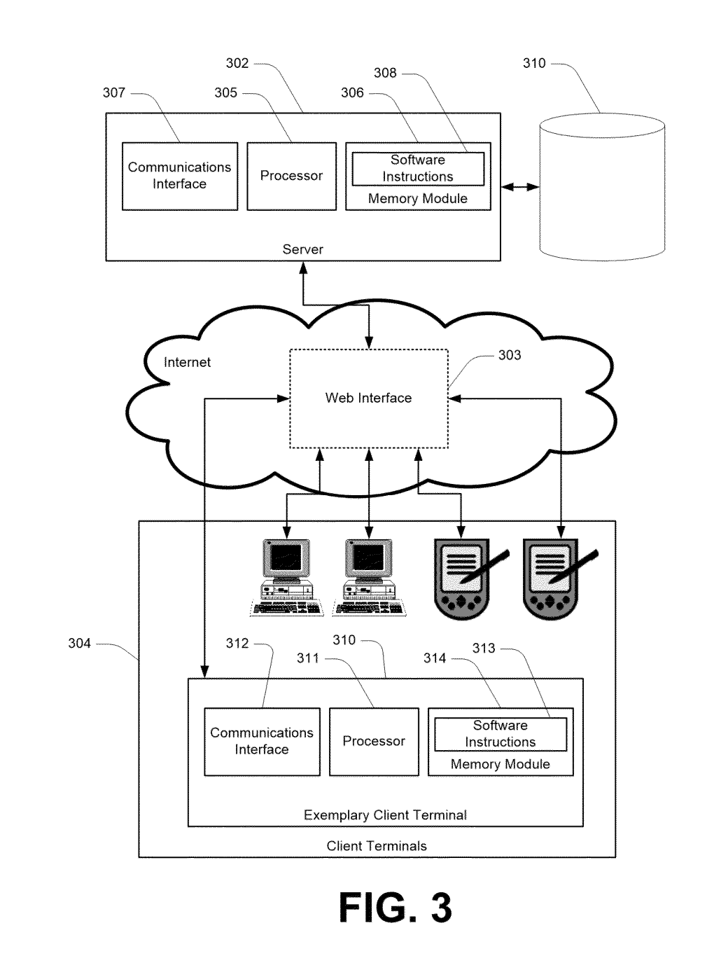

In some embodiments, methods and functionalities considered herein are implemented by way of a client-server framework, as illustrated in FIG. 3. For example, this may include the delivery of user interfaces for rendering at any one or more of client terminals 110a-110n, 150, and/or 160a-160n.

In overview, a web server 302 provides a web interface 303. This web interface is accessed by the parties by way of client terminals 304. In overview, users access interface 303 over the Internet by way of client terminals 304, which in various embodiments include the likes of personal computers, PDAs, cellular telephones, gaming consoles, and other Internet enabled devices.

Server 303 includes a processor 305 coupled to a memory module 306 and a communications interface 307, such as an Internet connection, modem, Ethernet port, wireless network card, serial port, or the like. In other embodiments distributed resources are used. For example, in one embodiment server 302 includes a plurality of distributed servers having respective storage, processing and communications resources. Memory module 306 includes software instructions 308, which are executable on processor 305.

Server 302 is coupled to a database 310. In further embodiments the database leverages memory module 306.

In some embodiments web interface 303 includes a website. The term “website” should be read broadly to cover substantially any source of information accessible over the Internet or another communications network (such as WAN, LAN or WLAN) via a browser application running on a client terminal. In some embodiments, a website is a source of information made available by a server and accessible over the Internet by a web-browser application running on a client terminal. The web-browser application downloads code, such as HTML code, from the server. This code is executable through the web-browser on the client terminal for providing a graphical and often interactive representation of the website on the client terminal. By way of the web-browser application, a user of the client terminal is able to navigate between and throughout various web pages provided by the website, and access various functionalities that are provided.

Although some embodiments make use of a website/browser-based implementation, in other embodiments proprietary software methods are implemented as an alternative. For example, in such embodiments client terminals 304 maintain software instructions for a computer program product that essentially provides access to a portal via which framework 100 is accessed (for instance via an iPhone app or the like).

In general terms, each terminal 304 includes a processor 311 coupled to a memory module 313 and a communications interface 312, such as an internet connection, modem, Ethernet port, serial port, or the like. Memory module 313 includes software instructions 314, which are executable on processor 311. These software instructions allow terminal 304 to execute a software application, such as a proprietary application or web browser application and thereby render on-screen a user interface and allow communication with server 302. This user interface allows for the creation, viewing and administration of profiles, access to the internal communications interface, and various other functionalities.

### Conclusions and Interpretation

It will be appreciated that the disclosure above provides various significant frameworks and methodologies configured to determine probabilistic desire for goods and/or services.

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A computer implemented method for determining probabilistic desire for goods and/or services, the method including:
(i) receiving, via networked communications from a plurality of client sites, data collected via instances of practice management software respectively executing that the plurality of client sites, wherein the data is indicative of consumer behaviour recorded by the instances of practice management software;
(ii) updating a data repository that maintains, for each of a set of identified consumers, data indicative of consumer behaviour;
(iii) maintaining access to a set of one or more desire prediction rules, wherein each desire prediction rules is satisfiable based on the data indicative of consumer behaviour;
(iv) monitoring the data indicative of consumer behaviour thereby to determine whether any of the desire prediction rules are satisfied in respect any of the consumers; and
(v) in the case that a given one of the desire prediction rules is satisfied in respect of the specific one of the consumers, performing an action associated with that one of the desire prediction rules.

2. A method according to claim 1 wherein the instances of practice management software are instances of real estate practice management software.

3. A method according to claim 2 wherein the data indicative of consumer behaviour is indicative of consumer behaviour observed in relation to real estate activities.

4. A method according to claim 3 wherein the consumer behaviour observed in relation to real estate activities includes data relating to any one or more of the following activities:
(a) making an enquiry;
(b) attendance at a property viewing;
(c) attendance at a property auction;
(d) the making of an offer in respect of a property;
(e) request/obtaining of a contract in respect of a property;
(f) a settlement in respect of a property purchase;
(g) determination of a settlement date in respect of a property purchase; and
(h) determination of occupation commencement date in respect of a property rental.

5. A method according to claim 4 wherein the data relating to any one or more of the activities includes, for a given one of the activities, any one or more of: a date; a value; a value range; and a location.

6. A method according to claim 1 wherein updating the data repository that maintains, for each of a set of identified consumers, data indicative of consumer behaviour, includes, for each of a plurality of data packets received from the client sites:
receiving the data packet;
processing the data packet thereby to extract identification data and behaviour data;
querying the data repository thereby to identify a consumer record corresponding to the identification data; and
associating the behaviour data with the identified consumer record.

7. A method according to claim 6 wherein: a first client site maintains, for its instance of practice management software, a first set of data relating to a first consumer; a second a second client site maintains, for its instance of practice management software, a second set of data relating to a the consumer, but independent of the first set of data; and wherein the data repository amalgamates data indicative consumer behaviour for the first consumer derived from the first and second sites.

8. A method according to claim 6 wherein the client sites include a first group of client sites which share consumer data between themselves and a second group of client sites which share consumer data between themselves, wherein members of the first group do not share consumer data with members of the second group.

9. A method according to claim 1 wherein each desire prediction rule is associated with a specific product, wherein the product includes any one or more of the following:
financial services;
legal services;
utilities services;
household services; and
insurance services.

10. A method according to claim 1 wherein each desire prediction rule is associated with a specific product, wherein the product includes any one or more of the following financial services: home loans; bridging loans; annuity products; financial planning services.

11. A method according to claim 1 wherein each desire prediction rule is associated with a specific product, wherein the product includes any one or more of the following insurance services: building insurance; mortgage insurance; home and contents insurance; loan protection insurance; landlord insurance; life insurance; and income protection insurance.

12. A method according to claim 1 wherein each desire prediction rule is associated with a specific product, wherein the product includes any one or more of the following legal services: conveyancing; insolvency; and family law.

13. A method according to claim 1 wherein each desire prediction rule is associated with a specific product, and the rule is satisfied when data indicative of behaviour for a given consumer represents a predefined point in a product desire timeline.

14. A method according to claim 13 wherein the action includes generating a lead, and wherein the method further includes monitoring conversion of leads in respect of a given product, and in response selectively varying the predefined point in a product desire timeline for that product.

15. A method according to claim 1 wherein the action includes generating a notification indicative of an identified threshold probabilistic desire for the specific one of the consumers in respect of a product associated with the satisfied desire prediction rule.

16. A computer implemented method for determining probabilistic desire for goods and/or services, the method including:
(i) receiving, via networked communications from a plurality of client sites, data collected via instances of real estate practice management software respectively executing that the plurality of client sites, wherein the data is indicative of consumer behaviour recorded by the instances of real estate practice management software;
(ii) maintaining access to a set of one or more desire prediction rules, wherein each desire prediction rule is satisfiable based on the data indicative of consumer behaviour;
(iii) monitoring the data indicative of consumer behaviour thereby to determine whether any of the desire prediction rules are satisfied in respect any of the consumers; and
(iv) in the case that a given one of the desire prediction rules is satisfied in respect of the specific one of the consumers, performing an action associated with that one of the desire prediction rules.

17. A computer implemented method for determining probabilistic desire for a home loan product, the method including:
(i) receiving, via networked communications from a plurality of client sites, data collected via instances of real estate practice management software respectively executing that the plurality of client sites, wherein the data is indicative of consumer behaviour recorded by the instances of real estate practice management software;
(ii) monitoring the data indicative of consumer behaviour based on a prediction algorithm thereby to identify one or more consumers having a threshold predicted probabilistic desire for a home loan; and
(iii) providing a notification identifying the one or more consumers having a threshold predicted probabilistic desire for a home loan.
